(19) United States
(12) Patent Application Publication
(10) Pub. No.: US 2005/0083204 A1
(43) Pub. Date: Apr. 21, 2005

(54) Monitoring apparatus and method

(76) Inventor: Jay T. Stewart, Scottsdale, AZ (US)

Correspondence Address: Jay T. Stewart, 6105 E Aire Libre Ln, Scottsdale, AZ, 85254, US

(21) Appl. No.: 10/688,232

(22) Filed: Oct. 16, 2003

(51) Int. Cl. G08B 23/00

(52) U.S. Cl. 340/573.1; 340/539.15

(57) ABSTRACT

A device for inhibiting the audio output of a monitoring system for a predetermined period of time. The device further includes the ability to choose from a plurality of predetermined periods of time. The device further includes a visual indication that said audio output is inhibited.

### BACKGROUND OF THE INVENTION

Systems capable of remotely monitoring children are now commonplace. These systems, often referred to as “baby monitors,” may be used to monitor the activity of a child from a remote location. Typically, baby monitor systems include two devices: one device capable of detecting sounds of the child and transmitting signals representative of those sounds (the “transmitter”); the other device capable of receiving signals from the transmitter and converting them back into audible sounds (the “receiver”). The transmitter may be placed at a location near the child; the receiver may be placed at a location remote from the child. The user of a baby monitor system, such as a parent, may then monitor the activities of the child without being in the child's immediate vicinity. Although baby monitors typically include one receiver, more than one receiver may be used. Additional receivers would allow the parent to monitor the child from multiple remote locations.

In addition to monitoring the activities of children, baby monitor systems may also be used to monitor the activities of adults or animals. Therefore, terms such as “baby monitor system” or “child monitoring device,” or references to a “child” being monitored, are used here merely for convenience when disclosing embodiments of the invention, and shall not in any way limit the scope of the invention to systems used for monitoring children.

As the inventor has recently learned, before falling asleep young children will often cry for a period of time after being placed into their crib, bed, Pack 'n Play®, etc. (the child's “cry-time”). After the child's cry-time, the child will typically (hopefully) sleep for an extended period of time. Today's baby monitor systems fail to address the existence of this short period of cry-time before sleep. As a result, during the child's cry-time, the parent must listen to the child's crying on the baby monitor system's receiver, turn down the receiver's volume, or turn off the receiver's power. If the parent chooses to turn down the receiver's volume or chooses to turn off the receiver, there is a good chance that, after the child's cry-time, the parent will forget to return the volume to its normal setting or forget to turn the receiver's power back on. In that case, the baby monitor system is defeated, and, if the child needs attention after his/her cry-time, the parent would not receive any indication.

### BRIEF DESCRIPTION OF THE DRAWINGS

The present invention will be understood more fully from the accompanying drawings of various embodiments of the invention. These drawings should not be taken to limit the invention to the specific embodiments, but are for explanation and understanding only.

FIG. 1 shows an embodiment of an improved monitoring system.

FIG. 2 shows an alternative embodiment for the receiver of an improved monitoring system.

FIG. 3 shows a further alternative embodiment for the receiver of an improved monitoring system.

FIG. 4 shows an example of the operational blocks associated with the receiver of an improved monitoring system.

### DETAILED DESCRIPTION OF THE INVENTION

The present invention will also be understood more fully through the detailed description below. This description should not be taken to limit the invention to the specific embodiments, but is for explanation and understanding only.

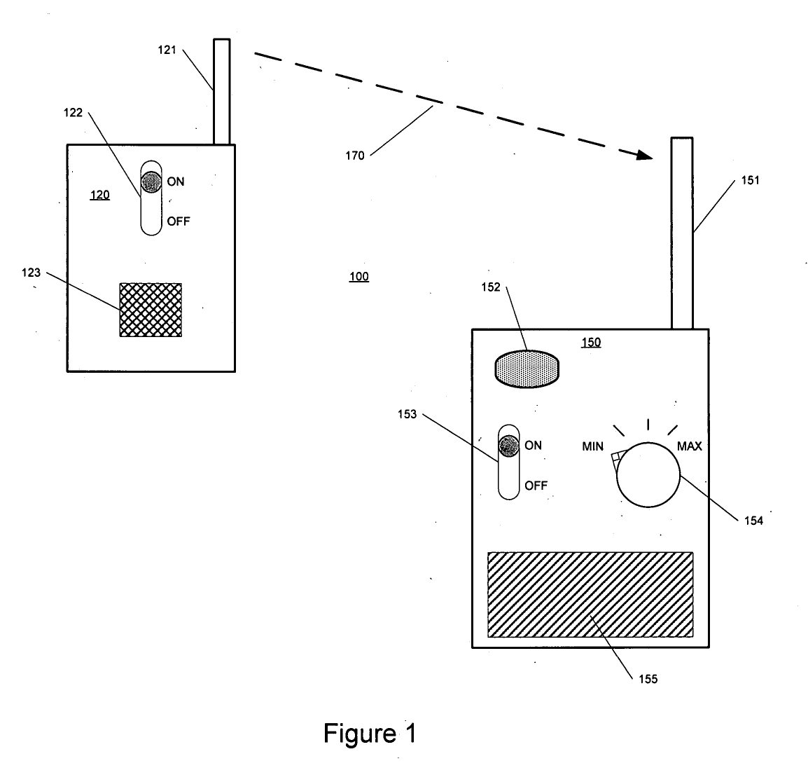

Embodiments of an apparatus and method for temporarily disabling the output of a monitoring system are disclosed. FIG. 1 depicts monitoring system 100, which may consist of two devices: transmitter 120, placed near a child being monitored, and receiver 150 placed at a location remote from the child. Although baby monitor systems typically include one receiver, the disclosed invention may also apply to each of a plurality of receivers in systems that include more than one receiver.

Transmitter 120 of monitoring system 100 includes microphone 123 which detects sounds made by a child being monitored. Transmitter 120 converts those sounds into radio frequency (RF) signals 170 which are transmitted from antenna 121 to receiver 150. Transmitter 120 also includes power switch 122 that controls whether transmitter 120 is powered up and transmitting signals to receiver 150. Although transmitter 120 in monitoring system 100 is shown using RF signals 170 to communicate with receiver 150, the claimed invention is not limited to such a communication method. Other wireless and wired communication methods between transmitter 120 and receiver 150 may also be used in conjunction with the claimed invention.

Receiver 150 of monitoring system 100 includes antenna 151 which receives RF signals 170 from transmitter 120. As used within current residential baby monitor systems, RF signals 170 are typically outside the AM and FM radio frequency ranges to avoid interfering with household radios. Also, the maximum wireless operating range for current residential baby monitor systems is typically on the order of 500 feet. Receiver 150 converts RF signals 170 to audible sounds which are generated by speaker 155. Receiver 150 also includes several controls. Power switch 153 determines whether receiver 150 is powered up. Volume control 154 establishes the volume of the sounds generated by speaker 155.

Receiver 150 also includes output inhibit button 152. When pressed, output inhibit button 152 inhibits the output of speaker 155 for a predetermined period of time. At the expiration of that predetermined period of time, speaker 155 is reactivated such that it produces sounds at the volume level established by volume control 154. If output inhibit button 152 is pressed while the output of speaker 155 is already inhibited, the output of speaker 155 is reactivated as if the predetermined period of time had expired. Alternatively, the pressing of output inhibit button 152 while the output of speaker 155 is already inhibited may reset the running of the predetermined period of time such that the output of speaker 155 is again inhibited for the full predetermined period time. In the latter case, in order to reactivate the output of speaker 155 before the expiration of the predetermined period of time, the receiver power may be cycled from on, to off, to on again.

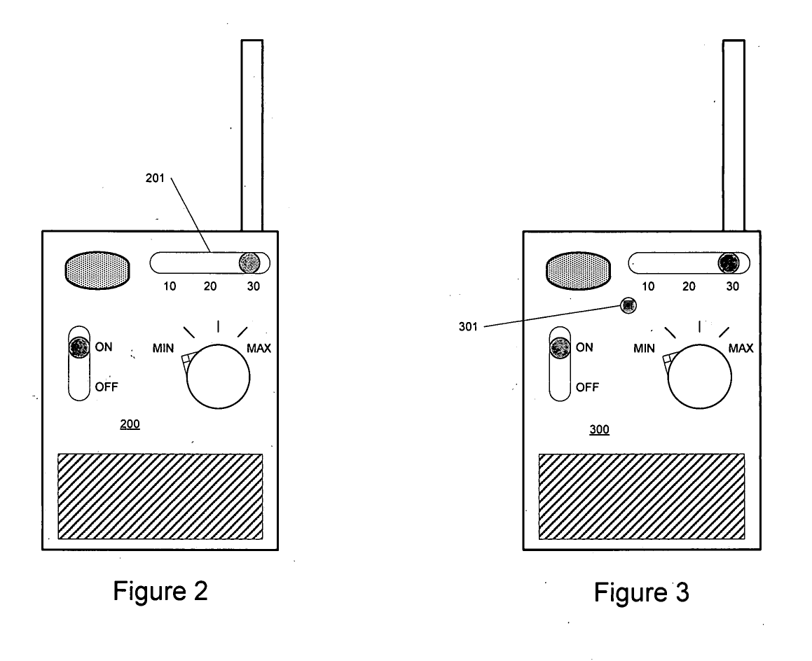

FIG. 2 shows an alternate receiver embodiment for monitoring system 100. Receiver 200 includes inhibit time selection switch 201 that allows the user to select from three different lengths of time for which the output of speaker 155 is inhibited. For example, the three selectable times may be 10, 20, and 30 minutes. When output inhibit button 152 is pressed, the output of speaker 155 is inhibited for the length of time selected by inhibit time selection switch 201.

FIG. 3 shows an alternate receiver embodiment for monitoring system 100 which further includes output inhibit indicator 301. Output inhibit indicator 301, which may consist of a light emitting diode (LED), illuminates while the output of speaker 155 is inhibited. Output inhibit indicator 301 remains illuminated until the output of speaker 155 is reactivated.

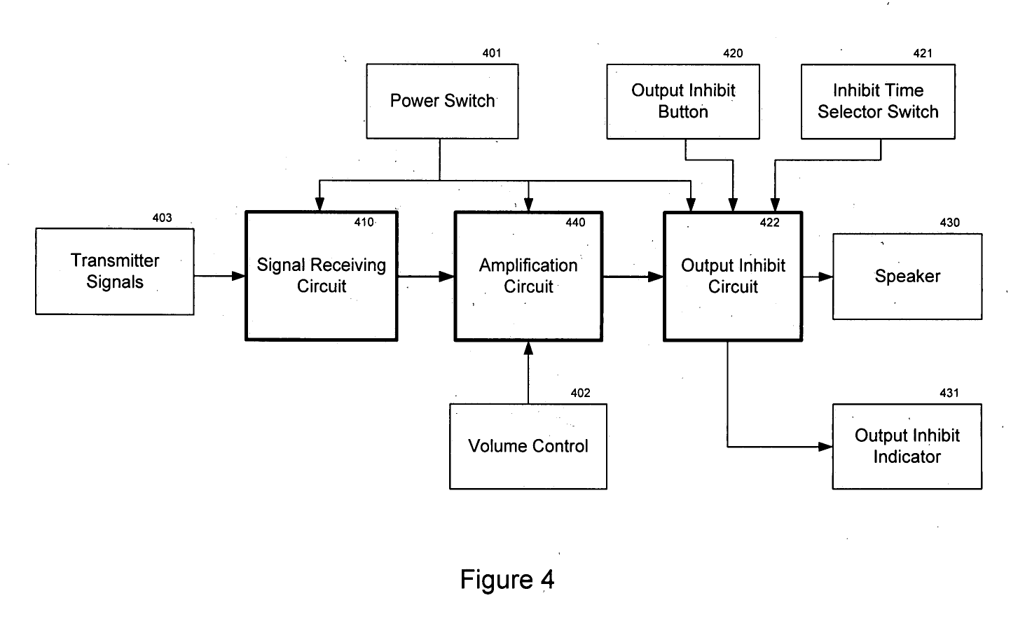

FIG. 4 shows operational blocks for receiver 150 of monitoring system 100. Power switch 401 determines whether the circuitry of receiver 150 (i.e., signal receiving circuit 410, amplification circuit 440, and output inhibit circuit 422) is powered on or off. When powered on, signal receiving circuit. 410 receives transmitter signals 403 from transmitter 120 through a wired or wireless connection. Amplification circuit 440 receives signals from signal receiving circuit 410 and amplifies those signals in accordance with the level established by volume control 402. Output inhibit circuit 422, which may optionally be integrated into amplification circuit 440, is activated by output inhibit button 420. When output inhibit circuit 422 is deactivated, it passes the output of amplification circuit 440 to speaker 430. When output inhibit circuit 422 is activated, it reduces the level of the output of amplification circuit 440 before passing it to speaker 430. Output inhibit circuit 422 may also illuminate output inhibit indicator 431 to indicate when output inhibit circuit 422 is activated. Without the use of inhibit time selector switch 421, output inhibit circuit 422 is activated for a predetermined period of time, such as 15 minutes. With the use of inhibit time selector switch 421, output inhibit circuit 422 is activated for the period of time selected by the position of inhibit time selector switch 421.

Alternatively, if output inhibit circuit 422 and amplification circuit 440 are integrated into a single circuit, the combined circuit would reduce the amplification level established by volume control 402 during the period of time the output is to be inhibited. The output of such a combined circuit is then passed to speaker 430.

Whereas many alterations and modifications of the present invention will become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims.

1. A receiving device of a monitoring system comprising:
a signal receiving circuit to wirelessly receive signals, wherein said signal receiving circuit's maximum wireless operating range is less than one kilometer;
a speaker to reproduce sounds represented by said signals;
an output inhibit circuit to reduce the output of said speaker for a predetermined period of time; and
an output inhibit initiator to activate said output inhibit circuit.

2. The receiving device of claim 1 further comprising:
an output inhibit time selector to select said predetermined period of time from a plurality of selectable times.

3. The receiving device of claim 1 wherein said output inhibit circuit is deactivated if said output inhibit initiator is selected while said output inhibit circuit is activated.

4. The receiving device of claim 2 wherein said output inhibit circuit is deactivated if said output inhibit initiator is selected while said output inhibit circuit is activated.

5. The receiving device of claim 1 wherein said predetermined period time is restarted if said output inhibit initiator is selected while said output inhibit circuit is activated.

6. The receiving device of claim 1 wherein said predetermined period of time is set to a period of time from 5 to 60 minutes in length.

7. The receiving device of claim 1 wherein said output inhibit initiator comprises a momentary pushbutton switch.

8. The receiving device of claim 1 wherein said signal receiving circuit operates outside the frequency range of 88 to 108 MHz and outside the frequency range of 5.3 to 16 kHz.

9. The receiving device of claim 1 further comprising:
an output inhibit indicator to indicate when the output inhibit circuit is activated.

10. A receiving device of a monitoring system comprising:
a signal receiving circuit to receive signals through a wired connection;
a speaker to reproduce sounds represented by said signals;
an output inhibit circuit to reduce the output of said speaker for a predetermined period of time; and
an output inhibit initiator to activate said output inhibit circuit.

11. The receiving device of claim 10 further comprising:
an output inhibit time selector to select said predetermined period of time from a plurality of selectable times.

12. The receiving device of claim 10 wherein said output inhibit circuit is deactivated if said output inhibit initiator is selected while said output inhibit circuit is activated.

13. The receiving device of claim 10 wherein said predetermined period time is restarted if said output inhibit initiator is selected while said output inhibit circuit is activated.

14. A receiving device of a monitoring system comprising:
a signal receiving circuit to receive signals representing sounds;
a speaker to reproduce said sounds;
an output inhibit circuit to disable the output of said speaker for a predetermined period of time;
an output inhibit initiator to activate and deactivate said output inhibit circuit when said output inhibit initiator is selected.

15. The receiving device of claim 14 further comprising:
an output inhibit indicator to indicate when the output inhibit circuit is activated.

16. A monitoring system comprising:
a transmitter to detect sounds made by a child or pet being monitored and to transmit signals representative of said sounds; and
a receiver comprising
a signal receiving circuit to receive said signals from said transmitter and to amplify said signals,
a speaker to reproduce said sounds based on amplified signals from said signal receiving circuit; and,
an output inhibit circuit to reduce the volume of said speaker for a predetermined period of time.

17. The monitoring system of claim 16 wherein said signal receiving circuit operates outside the frequency range of 88 to 108 MHz and outside the frequency range of 5.3 to 16 kHz.

18. A method of using a monitoring system comprising the steps of:
placing a transmitting device in close proximity to a child or pet such that said transmitting device transmits signals representative of sounds made by said child or pet;
placing a receiving device with an audible output at a location remote from said child or pet; and
inhibiting said audible output on said receiving device for a predetermined period of time by making a momentary selection of a switch on said receiving device.

19. The method of claim 18 further comprising the step of establishing said predetermined period of time by selecting a period of time from a plurality of selectable times.

20. An improved residential baby monitor system comprising a receiver with a speaker, wherein the improvement comprises an output inhibit pushbutton on said receiver to disable the output of said speaker for a predetermined period of time.
